(19) United States
(12) Patent Application Publication
(10) Pub. No.: US 2025/0353781 A1
(43) Pub. Date: Nov. 20, 2025

(54) GLASS CLOTH AND METHOD OF MANUFACTURE

(71) Applicant: Shin-Etsu Chemical Co., Ltd., Tokyo (JP)

(72) Inventors: Toshio SHIOBARA, Tokyo (JP); Yusuke TAGUCHI, Annaka-shi (JP); Ryunosuke NOMURA, Annaka-shi (JP)

(73) Assignee: Shin-Etsu Chemical Co., Ltd., Tokyo (JP)

(21) Appl. No.: 19/202,715

(22) Filed: May 8, 2025

(30) Foreign Application Priority Data
May 14, 2024 (JP) 2024-078411

(51) Int. Cl. C03C 13/00; C03C 3/06; C03C 3/091; C03C 25/68; C08J 5/24; D03D 15/267; D03D 15/33; D06M 11/05; D06M 101/16

(52) U.S. Cl. CPC C03C 13/00; C03C 3/06; C03C 3/091; C03C 25/68; C08J 5/244; D03D 15/267; D03D 15/33; D06M 11/05; C03C 2201/02; C03C 2203/50; C03C 2213/00; D06M 2101/16; D10B 2401/00; D10B 2505/02

(57) ABSTRACT

In a glass cloth made of glass having a composition that is at least 50 wt % SiO₂, one of a warp and a weft that constitute the glass cloth has a filament diameter of less than 3.0 μm, and the glass cloth has a thickness of 15 μm or less and a weight of 10 g/m² or less.

### CROSS-REFERENCE TO RELATED APPLICATIONS

This non-provisional application claims priority under 35 U.S.C. § 119(a) on Patent Application No. 2024-078411 filed in Japan on May 14, 2024, the entire contents of which are hereby incorporated by reference.

### TECHNICAL FIELD

The present invention relates to a novel ultra-thin and low-weight glass cloth, a method of manufacturing the glass cloth, a composite material containing the glass cloth and an organic resin, and a method of adjusting the filament diameter of the glass cloth. The present invention also relates to an ultra-thin quartz glass cloth produced by using natural or synthetic quartz as a raw material and having excellent dielectric properties.

### BACKGROUND ART

With the trend today toward higher performance and faster communications in information devices such as smartphones, remarkable advances are being made toward achieving, in the printed wiring boards used in such devices, higher densities and ultrathin dimensions, and also lower permittivity and dielectric loss tangent. Laminates produced by stacking prepregs obtained by impregnating a glass cloth with an epoxy resin or other thermosetting resin (referred to below as the “matrix resin”) and curing under applied heat and pressure are widely used as the insulation material in such printed wiring boards.

To achieve ultrathin dimensions in a printed wiring board, the glass cloth itself must be made ultrathin. The glass cloth is produced by collecting a plurality of filaments into a strand, applying twist to the strand so as to form a yarn, then weaving such yarns into a cloth. In other words, it is important to reduce the diameter of individual filaments.

In JP-A 2008-117169 (Patent Document 1), a glass cloth having a filament diameter of 4 μm is obtained, but glass cloth having an even smaller filament diameter will be needed to satisfy the future demand for thinner glass cloth. Japanese Patent No. 6818278 (Patent Document 2) reports, as a low weight glass cloth, a glass cloth composed of filaments with a diameter in the range of 3.0 to 4.2 and having a thickness in the range of 7.5 to 12.0 μm and a weight in the range of 6.0 to 10.0 g per m².

However, glass filaments with a filament diameter of less than 3 μm has a very low strength because the fibers are so slender, and so the filaments often break and form fuzz when they are collected into strands or when the strands are twisted into yarn, causing problems during warping and making it difficult to weave. Furthermore, the yarn itself is very light in weight, and thus various problems arise during weaving on an air jet loom, such as the inability to propel the weft in a straight path. As described in JIS R 3413: 2012 (Non-Patent Document 1), glass fibers of less than 3 μm are not defined.

There is also a demand for a bonding film for adhesion between a low-profile copper foil and a printed wiring board. The use of glass cloth together with such a bonding film has been considered to improve strength and reduce thermal expansion, leading to a demand for ultra-thin glass cloth. There is also a demand for thinner multilayer printed wiring boards, and prepregs composed of ultra-thin glass cloth and organic resin are desired.

### CITATION LIST

Patent Document 1: Japanese Patent No. 6818278
Non-Patent Document 1: JIS R 3413: 2012

### SUMMARY OF THE INVENTION

It is therefore an object of the present invention to provide a glass cloth that has a filament diameter of less than 3.0 μm, a thickness of 15 μm or less, a weight of 10 g/m² or less, and an air permeability of 50 (cm³/cm²/s) or more, and an excellent dielectric loss tangent.

We have conducted intensive investigations aimed at achieving the above object, as a result of which we have discovered that by weaving a glass cloth from glass filaments and subsequently etching the glass cloth to reduce the filament diameter, a glass cloth having a filament diameter of less than 3 μm and a thickness of 15 μm or less can be obtained while avoiding problems during weaving, completing the present invention.

The present invention thus provides the following inventions.

Accordingly, in a first aspect, the invention provides a glass cloth made of glass having a composition that is at least 50 wt % SiO₂, wherein one of a warp and a weft that constitute the glass cloth has a filament diameter of less than 3.0 μm, and the glass cloth has a thickness of 15 μm or less and a weight of 10 g/m² or less.

In a preferred embodiment of the glass cloth of the invention, the composition includes a combined amount of SiO₂ and B₂O₃ that is 65 wt % or more.

In another preferred embodiment of the inventive glass cloth, the composition is at least 95 wt % SiO₂, and the glass cloth has a thickness of 10 μm or less.

In another preferred embodiment of the inventive glass cloth, the glass cloth has an air permeability of 50 (cm³/cm²/s) or more.

In a second aspect, the invention provides a method of manufacturing glass cloth, which method includes the step of etching the glass cloth with one or more etching solution selected from the group consisting of hydrofluoric acid, aqueous ammonium fluoride, aqueous sodium hydroxide, aqueous potassium hydroxide, aqueous sodium carbonate, ammonia water and alkaline electrolyzed water.

In a third aspect, the invention provides a method of adjusting the filament diameter of a glass cloth, which method includes the step of etching away at least 0.1 μm of the filament diameter of the glass cloth by treating the glass cloth with one or more etching solution selected from the group consisting of hydrofluoric acid, aqueous ammonium fluoride, aqueous sodium hydroxide, aqueous potassium hydroxide, aqueous sodium carbonate, ammonia water and alkaline electrolyzed water.

In a preferred embodiment of the glass cloth filament diameter adjusting method according to the third aspect of the invention, the etching solution is alkaline electrolyzed water having a pH of 12 or more.

In another preferred embodiment of the filament diameter adjusting method of the invention, glass cloth having a filament diameter of 3.0 μm or more is etched with an etching solution to adjust the filament diameter to less than 3.0 μm.

In a fourth aspect, the invention provides a composite material which includes the glass cloth according to the first aspect of the invention and an organic resin.

### Advantageous Effects of Invention

The present invention can solve technical problems in spinning, twisting, and weaving processes caused by glass filaments with extremely fine fiber diameters and thus can provide a glass cloth that has a filament diameter of less than 3.0 μm, a thickness of 15 μm or less, a weight of 10 g/m² or less, and an air permeability of 50 (cm³/cm²/s) or more, and an excellent dielectric loss tangent. This glass cloth has outstanding effects in that it makes it possible to adapt to the multilayering of printed wiring boards used in 5G and other high-speed communication technologies which will see increasing use in the future and it can hold down transmission loss.

### DETAILED DESCRIPTION OF THE INVENTION

The objects, features and advantages of the invention will become more apparent from the following detailed description.

### [Glass Ingredients]

The glass used in the glass cloth of the invention has a composition which is at least 50 wt % SiO₂. At a SiO₂ content below 50 wt %, in the subsequently described etching step, other metallic ingredients become major ingredients of the glass cloth and melting proceeds non-uniformly, resulting in variations in filament diameter and the appearance of brittleness in the glass cloth. From the standpoint of electrical characteristics such as the dielectric loss tangent and physical characteristics such as the coefficient of thermal expansion, the SiO₂ content of the quartz glass cloth is preferably 95 wt % or more, and more preferably 98 wt % or more. Examples of other metallic ingredients include B₂O₃, Al₂O₃, MgO, CaO, ZnO, Fe₂O₃, Li₂O, TiO₂, Na₂O, SrO, Cr₂O₃, As₂O₃, Sb₂O₃, P₂O₅, ZrO₂, Cl₂, SO₃, and MoO₂. These may be included in any proportions within ranges where the glass cloth of the invention can be produced. Increasing the content of SiO₂ and B₂O₃ can enhance the dielectric properties, and so the combined content of SiO₂ and B₂O₃ is preferably 65 wt % or more, and more preferably 70 wt % or more. The content of SiO₂ is even more preferably 95 wt % or more.

### [Glass Cloth]

One of the warp and the weft that constitute the glass cloth has a filament diameter of less than 3.0 μm, preferably from 0.1 to 2.9 μm, and more preferably from 0.5 to 2.5 μm. The warp and the weft preferably have the filament diameter described above. At a filament diameter of 0.1 μm or more, a film composed of the glass cloth and an organic resin has better dielectric properties, higher strength, and lower thermal expansion. The filament diameter is the average value of measurements taken under a microscope at ten places on a filament.

The glass cloth has a thickness of 15 μm or less, and preferably 10 μm or less. There is no particular lower limit, although a minimum thickness of 0.5 μm or more may be suitably selected. The thickness of the glass cloth is measured according to the method for measuring the thickness of cloths and mats described in JIS R 3420.

The glass cloth has a weight of 10 g/m² or less, and preferably 8 g/m² or less. There is no particular lower limit, although a minimum weight of 0.3 g/m² or more may be suitably selected. The weight of the glass cloth is measured according to the method for measuring the weight of cloths and mats described in JIS R 3420. The glass cloth has an air permeability (cm³/cm²/s) of preferably 50 or more, and more preferably 100 or more. There is no particular upper limit, although a maximum air permeability of 500 or less may be suitably selected. The air permeability of the glass cloth is measured according to the method for measuring the air permeability of cloths described in JIS R 3420.

The glass cloth has a dielectric loss tangent at 10 G Hz which is preferably less than 0.0070, more preferably 0.0020 or less, and even more preferably 0.0010 or less. Measurement of the dielectric loss tangent is based on the resonance method. This is described in detail in the subsequent “Examples” section. In addition, the surface of the glass cloth may have a silane coupling agent adhering thereto. This is explained in the description of the method of manufacturing the glass cloth.

### [Method of Manufacturing Glass Cloth]

The method of manufacturing the glass cloth of the invention is not particularly limited. For example, the method may be one which includes a glass cloth etching step.

### [Glass Cloth Prior to Etching]

The method of producing the initial glass cloth prior to etching, although not particularly limited, is preferably one which produces glass filaments, collects the filaments into strands, applies twist to the strands so as to produce yarn, and then weaves the yarn into glass cloth on a loom.

Glass filament producing methods include, without particular limitation, the method of drawing filaments under heating from an ingot of a prescribed glass formulation, and the method of melting starting materials to form molten glass and then using a bushing to extrude the glass as filaments. At a SiO₂ content of 95 wt % or more, the high melting temperature of the glass makes drawing the glass into filaments with a bushing difficult, and so hot drawing with the use of an oxyhydrogen burner is preferred.

A size agent is applied to the surfaces of the glass filaments and the filaments are collected together to form a glass strand. Twist is applied to the resulting glass strand, giving a glass yarn. The amount of twist is preferably from 0.1 to 5.0 turns per 25 mm.

Glass cloth can be manufactured by weaving glass yarn. When producing thin cloth as the glass cloth of the invention, the weight prior to etching is preferably from 5 to 50 g/m². To reduce the amount of subsequent etching, the weight prior to etching is more preferably from 5 to 25 g/m². Weaving methods include, without particular limitation, methods that involve the use of, for example, an air jet loom, waterjet loom, rapier loom or shuttle loom. When weaving is carried out with an air jet loom or the like, polyvinyl alcohol or starch may be applied as a secondary size agent to further achieve lubricity.

The glass cloth prior to etching has a filament diameter of preferably 3.0 μm or more, and more preferably 3.5 μm or more. The filament diameter may exceed 10 μm, and may even be set to from 11 to 25 μm. When the filament diameter is too large or the glass cloth is too thick, the amount of glass cloth required for etching increases, which is undesirable in terms of productivity.

### [Etching of Glass Cloth]

In particular, by etching the woven quartz glass cloth having the size agent thereon, the filament diameter can be adjusted while suppressing fuzz formation, in addition to which removal of the size agent is also possible. The etching solution for adjusting the filament diameter is not particularly limited. Examples include one or more etching solution selected from acidic aqueous solutions, such as hydrofluoric acid, an aqueous solution of acidic ammonium fluoride (NH₄F·HF), and an aqueous solution of acidic potassium fluoride (KHF₂), aqueous ammonium fluoride, aqueous sodium hydroxide, aqueous potassium hydroxide, aqueous sodium carbonate, ammonia water and alkaline electrolyzed water. Of these, in terms of the work environment and wastewater treatment, alkaline electrolyzed water having a pH of 12.0 or more (as measured at 25° C.) is preferred.

The glass cloth etching conditions are not particularly limited, so long as the filament diameter can be adjusted. The temperature is preferably between room temperature (23° C.) and 100° C., and more preferably between 4° and 80° C. At a temperature equal to or below room temperature, etching may proceed too slowly; at an etching temperature above 100° C., the amount of etching may be difficult to regulate. The treatment time is adjusted according to the treatment temperature and the target filament diameter. For example, under treatment at 60° C., the diameter of quartz glass fibers can be reduced at a rate of about 0.035 μm per hour. Within a range of between 4° and 80° C. in particular, the treatment time is preferably from 3 to 100 hours, more preferably from 12 to 80 hours, and even more preferably from 25 to 72 hours. After the target filament diameter has been reached, the glass cloth should be washed with pure or deionized water, until the pH of the washing fluid becomes 7, following which moisture adhering to the glass cloth is removed by drying under applied heat. The method of washing includes, without particular limitation, such methods as dipping in washing water and spraying with washing water. In the case of dipping, stress such as ultrasound treatment may be applied. The drying method also is not particularly limited. Exemplary drying methods include hot-air drying, infrared drying and drying on heated rollers.

### [Fiber-Opening of Glass Cloth]

Fiber-opening of the glass cloth can be performed by etching. Fiber-opening treatment of the glass cloth to obtain a predetermined degree of fiber opening is not particularly limited. Exemplary methods include fiber-opening treatment that utilizes ultrasound, treatment that employs a high-pressure, columnar water jet stream, and treatment which sprays a diffusion spray into the air. A method that utilizes a gas-liquid mixture mist having a calibrated air-water volume ratio is especially suitable in that the yarns in the fabric can be efficiently spread while suppressing strand slippage and fuzz formation. Since fuzz is also removed by etching, fuzz-free cloth can be produced. There is no particular limitation on the timing of fiber-opening treatment, although carrying it out before desizing is preferable in terms of taking advantage of the size agent lubricity. A Iso, because the size agent is removed during etching, the filaments more readily separate from one another, resulting in better fiber opening. With such a fiber-opening method, the air permeability of a thin glass cloth can be set to 300 cm³/cm²/s or below. The air permeability is preferably 30 cm³/cm²/s or more, more preferably 50 cm³/cm²/s or more, and even more preferably 50 to 280 cm³/cm²/s. The air permeability is measured according to the method for measuring the air permeability of cloths in JIS R 3420.

### [Silane Treatment of Glass Cloth]

The glass cloth that has been desized may be used directly as is or may be silane treated to give a silane-treated glass cloth. In the case of glass cloth that has been desized by prolonged etching, the etching reaction is a Si—O—Si bond breakage reaction (Si—O-Si+OH-→SiOH+SiO—), and thus SiOH groups readily form locally at the etched surface. By having the SiOH groups that have formed locally at the surface react with a silane coupling agent, the strength can be increased while lowering the dielectric loss tangent.

Examples of the silane coupling agent include, but are not limited to, alkoxysilane compounds such as trimethylmethoxysilane, trimethylethoxysilane, dimethyldimethoxysilane, dimethyldiethoxysilane, methylphenyldimethoxysilane, methylphenyldiethoxysilane, diphenyldimethoxysilane, diphenyldiethoxysilane, trimethoxysilane, triethoxysilane, methyltrimethoxysilane, methyltriethoxysilane, phenyltrimethoxysilane, phenyltriethoxysilane, phenylmethylvinylethoxysilane, naphthyltrimethoxysilane, naphthyltriethoxysilane, 1,4-bis(methoxydimethylsilyl)benzene, tetramethoxysilane, tetraethoxysilane, n-propyltriethoxysilane, hexyltrimethoxysilane, octyltriethoxysilane, decyltrimethoxysilane, 1,6-bis(trimethoxysilyl)hexane, vinyltrimethoxysilane, vinyltriethoxysilane, p-styryltrimethoxysilane, 3-aminopropyltrimethoxysilane, 3-glycidoxypropyltrimethoxysilane, 3-glycidoxypropylmethyldimethoxysilane, 3-glycidoxypropyltriethoxysilane, 3-glycidoxypropylmethyldiethoxysilane, 2-(3,4-epoxycyclohexyl)ethyltrimethoxysilane, 2-(3,4-epoxycyclohexyl)ethylmethyldimethoxysilane, 3-methacryloxypropyltrimethoxysilane, 3-methacryloxypropyldimethoxysilane, 3-methacryloxypropyltriethoxysilane, 3-methacryloxypropyldiethoxysilane, N-(2-aminoethyl)-3-aminopropyltrimethoxysilane, N-(2-aminoethyl)-3-aminopropylmethyldimethoxysilane, N-(2-aminoethyl)-3-aminopropyltriethoxysilane, N-(2-aminoethyl)-3-aminopropylmethyldiethoxysilane, N-phenyl-3-aminopropyltrimethoxysilane, N-(vinylbenzyl)-2-aminoethyl-3-aminopropyltrimethoxysilane and the hydrochloride thereof, N-(vinylbenzyl)-2-aminoethyl-3-aminopropylmethyldimethoxysilane and the hydrochloride thereof, 3-isocyanatopropyltriethoxysilane, tris(trimethoxysilylpropyl) isocyanurate, 3-ureidopropyltriethoxysilane, 3-chloropropyltrimethoxysilane, 3-mercaptopropyltrimethoxysilane, 3-mercaptopropylmethyldimethoxysilane and bis(triethoxysilylpropyl)tetrasulfide. One of these may be used alone or two or more may be used in admixture. Of these, 3-aminopropyltrimethoxysilane, N-(2-(aminoethyl)-3-aminopropyltrimethoxysilane and N-phenyl-3-aminiopropyltrimethoxysilane are preferred.

The silane treatment method is not particularly limited. Examples include the method of dipping the glass fibers in an aqueous solution in which a silane coupling agent has been dispersed, and treatment by roll coating. A silane treatment method which, once the target filament diameter has been reached by the etching treatment, adds a silane coupling agent to the etching solution is especially preferred as the method for silane treating thin glass cloth such as in this invention. The silane coupling agent is added in an amount that is preferably such that the pick-up of silane coupling agent on the surface of the glass cloth following silane treatment is from 0.01 to 1 wt %. For example, addition to a silane coupling agent concentration of from 0.01 to 1 wt % with respect to the etching solution is preferred. By having the pick-up of silane coupling agent on the glass cloth surface be 0.01 wt % or more, sufficient reaction with surface SiOH groups occurs, lowering the dielectric loss tangent. On the other hand, by having the pick-up of silane coupling agent on the glass cloth surface be 1 wt % or less, excess pick-up of the silane coupling agent on the surface of the glass cloth is avoided and the flexibility of the glass cloth is retained, in addition to which the dielectric loss tangent becomes lower. The treatment temperature is not particularly limited, although a temperature between 40° C. and 80° C. is preferred for the silane coupling agent to rapidly hydrolyze and react with the surface of the quartz glass cloth. The treatment time is not particularly limited, provided that it is a treatment time such that the pick-up of silane coupling agent on the glass cloth surface following silane treatment is, for example, from 0.01 to 1 wt %, although a treatment time of from 0.5 to 2 hours is preferred.

Following silane treatment, washing may be carried out with pure or deionized water until the pH of the washings becomes preferably 7. The moisture adhering to the glass cloth is then removed by drying under applied heat. At this time, excess silane coupling agent that is physically adsorbed and has not reacted with the glass cloth is removed.

### [Method of Adjusting Filament Diameter of Glass Cloth]

This invention provides a method of adjusting the filament diameter of a glass cloth, which method includes the step of etching away at least 0.1 μm of the filament diameter by treating the glass cloth with one or more etching solution selected from the group consisting of hydrofluoric acid, aqueous ammonium fluoride, aqueous sodium hydroxide, aqueous potassium hydroxide, aqueous sodium carbonate, ammonia water and alkaline electrolyzed water. The etching method is the same as in the above-described glass cloth manufacturing method. The treatment temperature and treatment time are adjusted according to the target filament diameter. In the etching treatment, the filament diameter is reduced by etching preferably by at least 0.1 μm, more preferably by at least 0.5 μm, and even more preferably by at least 1.0 μm. Although there is no upper limit, the reduction in the filament diameter may be suitably set to up to 10 μm.

The etching method is the same as the above-described method, and the etching solution used is preferably alkaline electrolyzed water having a pH of 12 or more. In particular, it is preferable for glass cloth having a filament diameter of 3.0 μm or more to be adjusted to a filament diameter of less than 3.0 μm by etching treatment with an etching solution. The filament diameter after etching is preferably from 0.1 to 2.9 μm, and more preferably from 0.5 to 2.5 μm.

### [Composite Material (Film)]

The glass cloth of the invention can be used to produce a thin film impregnated with an organic resin because of its excellent dielectric loss tangent, fine filament diameter, high air permeability, and thin thickness.

The film of the invention is particularly suitably used as an adhesive film with excellent dielectric loss tangent because the glass cloth, for example, improves the film strength and decreases the thermal expansion coefficient. Stacking multiple sheets of this adhesive film (prepreg) enables production of very thin printed wiring boards.

Examples of the organic resin include, without particular limitation, cyanate ester resins, bismaleimide-cyanate ester resins, epoxy resins, polyfunctional maleimide resins and unsaturated group-containing polyphenylene ether resins. One of these may be used alone or two or more may be used in combination. The amount of organic resin used falls within the known range for the art.

### EXAMPLES

The invention is illustrated more fully below by way of Examples and Comparative Examples, although the invention is not limited by these Examples.

### [Preparation Example of Size Agent for Quartz Glass Fibers]

### 1. Primary Size Agent:

A primary size agent for quartz glass fibers composed of 3.0 wt % starch, 0.5 wt % beef tallow and 0.1 wt % Emulmin (Sanyo Chemical Industries, Ltd.) as an emulsifying agent, with the balance being water, was prepared.

### 2. Secondary Size Agent:

An aqueous solution composed of 1.5 wt % polyvinyl alcohol, and 1.5 wt % starch, with the balance being water, was prepared.

### [Preparation Example of Glass Cloth]

### 1. Glass Cloth A:

A glass ingot composed of 53 wt % SiO₂, 8 wt % B₂O₃, 15 wt % Al₂O₃, 21 wt % CaO, 2 wt % MgO and 1 wt % each of Na₂O and K₂O was hot drawn to produce glass fiber consisting of 4 μm diameter glass filaments and the above glass fiber primary size agent was applied thereto with an applicator, following which the filaments were collected together and taken up, producing glass strand having a quartz glass filament count of 100. A twist of 24 T/m was applied to the wound-up glass strand to produce a glass yarn.

A secondary size agent was applied to the resulting glass yarn, following which glass cloth was manufactured on an air-jet loom at the weave density in IPC standard 1027. The resulting glass cloth with adhering size agent was subjected to fiber-opening treatment using a PSN slit nozzle from H. Ikeuchi Co., Ltd. and using 25° C., 0.3 M Pa tap water and air compressed to 0.3 M Pa at an air-water volume ratio V2/V1=35. The resulting glass cloth is denoted as “Glass Cloth A.”

### 2. Glass Cloth B:

Aside from setting the composition of the starting glass to 55 wt % SiO₂, 15 wt % B₂O₃, 15 wt % Al₂O₃, 12 wt % CaO, 2 wt % MgO and 1 wt % each of Na₂O and K₂O, glass fiber consisting of 4 μm diameter glass filaments was produced in the same way as Glass Cloth A, and a glass cloth was manufactured at the weave density in IPC standard 1027, followed by fiber-opening treatment. The resulting glass cloth is denoted as “Glass Cloth B.”

### 3. Glass Cloth C:

Aside from using a quartz glass ingot that was 99.9 wt % SiO₂, glass fiber consisting of 4 μm diameter glass filaments was produced in the same way as Glass Cloth A, and a glass cloth was manufactured at the weave density in IPC standard 1027, followed by fiber-opening treatment. The resulting glass cloth is denoted as “Glass Cloth C.”

### 4. Glass Cloth D:

Filaments having a diameter of 3.6 μm were produced using a quartz glass ingot that was 99.9 wt % SiO₂. The resulting filaments were collected into 38-filament strands to produce a quartz yarn in the same way as Glass Cloth A, and weaving was carried out, thereby manufacturing a glass cloth at the weave density in IPC standard 1006. The resulting glass cloth was denoted as “Glass Cloth D.”

### 5. Glass Cloth E: For Comparative Example

Aside from setting the composition of the starting glass to 40 wt % SiO₂, 8 wt % B₂O₃, 22 wt % Al₂O₃, 27 wt % CaO, 2 wt % MgO and 1 wt % each of Na₂O and K₂O, glass fiber consisting of 4 μm diameter glass filaments was produced in the same way as Glass Cloth A, and a glass cloth was manufactured at the weave density in IPC standard 1027, followed by fiber-opening treatment. The resulting glass cloth was denoted as “Glass Cloth E.”

### 6. Glass Cloth F: For Comparative Example

Filaments having a diameter of 2.5 μm were produced using a quartz glass ingot that was 99.9 wt % SiO₂. The resulting filaments were collected into 100-filament strands to produce a quartz yarn in the same way as Glass Cloth D, but the yarn yield was low due to frequent filament breakage. This yarn was woven to manufacture a glass cloth at the weave density in accordance with IPC Standard 1006. Fiber-opening treatment of the resulting glass cloth causes fiber breakage and formation of uneven basket holes, and no glass cloth was obtained.

The physical properties of the prepared glass clothes are shown in Table 1.

TABLE 1

| Glass cloth | A | B | C | D | E | F |
|---|---|---|---|---|---|---|
| Filament diameter (μm) | 4 | 4 | 4 | 3.6 | 4 | 2.5 |
| SiO₂ content (wt %) | 53 | 55 | 99.9 | 99.9 | 40 | 99.9 |
| SiO₂ + B₂O₃ content (wt %) | 61 | 70 | 99.9 | 99.9 | 48 | 99.9 |
| Cloth thickness (μm) | 20.0 | 20.0 | 20.0 | 11.0 | 20.0 | 7.8 |
| Weight (g/m²) | 20.0 | 17.7 | 16.5 | 7.5 | 20.5 | 7.8 |
| Glass cloth IPC standard | 1027 | 1027 | 1027 | 1006 | 1027 | 1027 |
| Weaving* | ∘ | ∘ | ∘ | ∘ | ∘ | x |

*∘: Y arn and glass cloth can be produced.
x: Filament breakage and cloth fiber breakage occur.

### Example 1

Glass Cloth A was placed in an alkali-resistant etching tank and S-2665 alkaline electrolyzed water (pH 12, as measured at 25° C.) from Suzukiyushi Industrial Co., Ltd. was poured in until the glass cloth was submerged. The tank was then airtightly closed and left at rest for 72 hours at 60° C., thereby carrying out etching. Next, 3-methacrylpropyltrimethoxysilane (KBM-503, from Shin-Etsu Chemical Co., Ltd.) was added in an amount of 0.2 wt % with respect to the alkaline electrolyzed water and 1 hour of treatment was carried out at 60° C. The alkaline electrolyzed water was then discharged from the etching tank and replaced (three times) with deionized water until the pH reached 7, thereby rinsing the quartz glass cloth. The rinsed and etched cloth was dried at 110° C. for 10 minutes using a DKN 602 forced-air convection oven from Yamato Scientific Co., Ltd.

The filament diameter, cloth thickness, weight, and air permeability of Glass Cloth A after etching are shown in Table 2.

### Example 2

Glass Cloth B was placed in an alkali-resistant etching tank and coupling treatment was carried out simultaneously with etching treatment in the same way as in Example 1, after which the glass cloth was rinsed and dried.

The filament diameter, cloth thickness, weight, and air permeability of Glass Cloth B after etching are shown in Table 2.

### Example 3

Glass Cloth C was placed in an alkali-resistant etching tank and coupling treatment was carried out simultaneously with etching treatment in the same way as in Example 1, after which the glass cloth was rinsed and dried.

The filament diameter, cloth thickness, weight, and air permeability of Glass Cloth C after etching are shown in Table 2.

### Example 4

Glass Cloth C was placed in an alkali-resistant etching tank and, aside from changing the etching time to 31 hours, treatment was carried out in the same way as in Example 3.

The filament diameter, cloth thickness, weight, and air permeability of Glass Cloth C after etching are shown in Table 2.

### Example 5

Glass Cloth C was placed in an alkali-resistant etching tank and, aside from changing the etching time to 100 hours, treatment was carried out in the same way as in Example 3.

The filament diameter, cloth thickness, weight, and air permeability of Glass Cloth C after etching are shown in Table 2.

### Example 6

Glass Cloth C was placed in an alkali-resistant etching tank and, aside from changing the etching temperature to 80° C. and the etching time to 100 hours, treatment was carried out in the same way as in Example 3.

The filament diameter, cloth thickness, weight, and air permeability of Glass Cloth C after etching are shown in Table 3.

### Example 7

Glass Cloth D was placed in an alkali-resistant etching tank and, aside from changing the etching temperature to 60° C. and the etching time to 60 hours, treatment was carried out in the same way as in Example 1.

The filament diameter, cloth thickness, weight, and air permeability of Glass Cloth D after etching are shown in Table 3.

### Comparative Example 1

Glass Cloth C was placed in an alkali-resistant etching tank and, aside from changing the etching temperature to 60° C. and the etching time to 10 hours, treatment was carried out in the same way as in Example 3.

The filament diameter, cloth thickness, weight, and air permeability of Glass Cloth C after etching are shown in Table 3.

### Comparative Example 2

Glass Cloth C was placed in an alkali-resistant etching tank and, aside from changing the etching temperature to 10° C. and the etching time to 110 hours, treatment was carried out in the same way as in Example 3.

The filament diameter, cloth thickness, weight, and air permeability of Glass Cloth C after etching are shown in Table 3.

### Comparative Example 3

Glass Cloth E was placed in an alkali-resistant etching tank and, aside from changing the etching temperature to 60° C. and the etching time to 31 hours, treatment was carried out in the same way as in Example 1.

The filament diameter, cloth thickness, weight, and air permeability of Glass Cloth E after etching are shown in Table 3.

The glass cloths obtained above were evaluated by the following methods. The results are presented in Tables 2 and 3 below.

### 1. Measurement of Filament Diameter:

The glass cloth was vertically fixed using a cold-setting epoxy resin (NER-814, from Nisshin-EM) and the surface was polished, following which the quartz glass filament diameter was measured in ten places with a scanning electron microscope (JSM-IT700HR InTouchScope, JEOL, Ltd.) and the average of these values was treated as the filament diameter.

### 2. Measurement of Thickness:

The thickness was measured in accordance with the cloth and mat thickness measurement method described in JIS R 3420.

### 3. Measurement of Basis Weight:

The weight was measured in accordance with the cloth and mat weight measurement method described in JIS R 3420.

### 4. Measurement of Air Permeability:

The air permeability was measured in accordance with the method of measuring the air permeability of cloth described in JIS R 3420.

### 5. Silane Coupling Agent Pick-up (Loss on Ignition)

The silane coupling agent pick-up was measured in accordance with the method for measuring the water content and the loss on ignition described in JIS R 3420.

### 6. Measurement of Dielectric Loss Tangent:

The dielectric loss tangent of glass cloth at 10 GHz was measured using a cavity resonator from AET, Inc. (TE011 mode). The thickness of the glass cloth was measured using the theoretical film thickness, the theoretical film thickness of glass cloth being computed as follows:

$$Theoretical film thickness t ( μm ) = weight ( g / {m}^{2} ) / specific gravity \\ \\ ( g / {cm}^{3} )$$

TABLE 2

| | | Example | | | | |
|---|---|---|---|---|---|---|
| | | 1 | 2 | 3 | 4 | 5 |
| Glass cloth | | A | B | C | C | C |
| Etching | Temperature (° C.) | 60 | 60 | 60 | 60 | 60 |
| conditions | Time (hr) | 72 | 72 | 72 | 31 | 100 |
| Glass cloth | Filament diameter (μm) | 1.5 | 1.5 | 1.5 | 2.9 | 0.5 |
| after etching | Cloth thickness (μm) | 7.1 | 6.9 | 7.0 | 14.7 | 4.1 |
| | Weight (g/m²) | 2.8 | 2.5 | 2.3 | 8.7 | 0.3 |
| | Air permeability (cm³/cm²/s) | 144 | 137 | 146 | 72 | 282 |
| | Loss on ignition (wt %) | 0.2 | 0.2 | 0.2 | 0.2 | 0.5 |
| | Dielectric loss tangent (10 GHz) | 0.0063 | 0.0015 | 0.0006 | 0.0006 | 0.0006 |

TABLE 3

| | | Example | | Comparative Example | | |
|---|---|---|---|---|---|---|
| | | 6 | 7 | 1 | 2 | 3 |
| Glass cloth | | C | D | C | C | E |
| Etching | Temperature (° C.) | 80 | 60 | 60 | 10 | 60 |
| conditions | Time (hr) | 100 | 60 | 10 | 110 | 31 |
| Glass cloth | Filament diameter (μm) | 0.2 | 1.5 | 3.6 | 4.0 | 3.2 |
| after etching | Cloth thickness (μm) | 1.9 | 6.7 | 18.0 | 20.0 | 16.0 |
| | Weight (g/m²) | 0.1 | 1.3 | 13.4 | 16.5 | 13.1 |
| | Air permeability (cm³/cm²/s) | 432 | 178 | 47 | 380 | 63 |
| | Loss on ignition (wt %) | 0.5 | 0.2 | 0.2 | 0.2 | 0.2 |
| | Dielectric loss tangent (10 GHz) | 0.0006 | 0.0006 | 0.0006 | 0.0006 | 0.070 |

The results in Tables 2 and 3 show that quartz glass cloth having a filament diameter of less than 3.0 μm, a thickness of 15 μm or less and a weight of 10 g/m² or less was obtained by the method of the invention. In the related art, filaments with filament diameters of less than 3.0 μm have been difficult to mass-produce, even though such filaments can be prototyped.

In this invention, by adjusting the filament diameter of conventional glass cloth at a later stage of production via etching treatment, it is possible to obtain thin quartz glass cloth having a filament diameter of 3.0 μm or less, which has to date been impossible to weave. The glass cloth of the invention thus enables printed wiring board integration applicable to high-speed communications technologies such as 5G which will see increasing use in the future and also helps to hold down transmission loss. In particular, the glass cloth of the invention is expected to be used as a thin-film glass cloth for reinforcing an adhesive film used with low-profile copper cladding.

Japanese Patent Application No. 2024-078411 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A glass cloth comprising glass having a composition that is at least 50 wt % SiO₂, wherein one of a warp and a weft that constitute the glass cloth has a filament diameter of less than 3.0 μm, and the glass cloth has a thickness of 15 μm or less and a weight of 10 g/m² or less.

2. The glass cloth of claim 1, wherein the composition includes a combined amount of SiO₂ and B₂O₃ that is 65 wt % or more.

3. The glass cloth of claim 1, wherein the composition is at least 95 wt % SiO₂, and the glass cloth has a thickness of 10 μm or less.

4. The glass cloth of claim 1, wherein the glass cloth has an air permeability of 50 (cm³/cm²/s) or more.

5. A method of manufacturing the glass cloth of claim 1, comprising the step of etching the glass cloth with one or more etching solution selected from the group consisting of hydrofluoric acid, aqueous ammonium fluoride, aqueous sodium hydroxide, aqueous potassium hydroxide, aqueous sodium carbonate, ammonia water and alkaline electrolyzed water.

6. A method of adjusting the filament diameter of a glass cloth, comprising the step of etching away at least 0.1 μm of the filament diameter of the glass cloth by treating the glass cloth with one or more etching solution selected from the group consisting of hydrofluoric acid, aqueous ammonium fluoride, aqueous sodium hydroxide, aqueous potassium hydroxide, aqueous sodium carbonate, ammonia water and alkaline electrolyzed water.

7. The filament diameter adjusting method of claim 6, wherein the etching solution is alkaline electrolyzed water having a pH of 12 or more.

8. The filament diameter adjusting method of claim 6, wherein glass cloth having a filament diameter of 3.0 μm or more is etched with an etching solution to adjust the filament diameter to less than 3.0 μm.

9. A composite material comprising the glass cloth of claim 1 and an organic resin.
